(19) United States
(12) Patent Application Publication
(10) Pub. No.: US 2004/0050324 A1
(43) Pub. Date: Mar. 18, 2004

(54) Layered painters shield

(76) Inventor: Mark H. Copp, Lantana, FL (US)

Correspondence Address: MCHALE & SLAVIN, P.A., 2855 PGA BLVD, PALM BEACH GARDENS, FL, 33410, US

(21) Appl. No.: 10/246,994

(22) Filed: Sep. 18, 2002

(51) Int. Cl. B05C 11/11

(52) U.S. Cl. 118/504

(57) ABSTRACT

This invention is directed to a paint shield, having a renewable protective pad of throw-away cover elements, allowing the painter to quickly renew the distal edge and working surface of his paint shield in order to prevent accumulated over-spray or brush paint from errantly being deposited or dripped onto other surfaces during operation. More specifically the device is constructed and arranged to renew the working face and distal edge of a paint shield by employing a pad of paint impervious cover elements. The protective pad is comprised of a plurality of cover elements disposed one on top of another, each cover element having readily releasable pressure-sensitive adhesive at least partially covering one face and being free of adhesive on the opposite face. The cover elements are stacked with the adhesive side of each element facing the non-adhesive side of the element below to maintain the elements in a layered protective pad. When an excessive amount of paint has accumulated on the surface of the top cover element, it can be peeled away to reveal a fresh cover element and operation continues.

### FIELD OF THE INVENTION

This invention is directed to a paint shield, having a renewable cover pad comprising throw-away cover elements, allowing the painter to quickly renew the distal edge and working surface of the paint shield in order to prevent accumulated paint or over-spray from errantly being deposited or dripped onto other surfaces during ordinary use. More specifically, the device is constructed and arranged to utilize a layered pad of paint impervious cover elements the lowermost cover element contiguous to the working surface and distal edge of a paint shield; each cover element layer of the cover pad having a readily releasable pressure-sensitive adhesive at least partially covering one face juxtaposed to a non-adhesive side of the element below to releasably secure the cover sheets to form a layered cover pad. When an excessive amount of paint has accumulated on the top cover element, it can be peeled off to reveal a fresh cover element for subsequent use.

### BACKGROUND OF THE INVENTION

Typically, a ceiling is covered with paint or texturing, which is different from that of the walls. Additionally, some walls, windows or trim are painted a different color from a surface adjacent thereto. Therefore, it is necessary to protect, e.g. mask, the first surface as a brush or roller paints the second surface.

Additionally a considerable amount of interior surface painting is now accomplished by spray painting. This is particularly true in commercial settings where high volume justifies the additional spray painting equipment expense.

An easily maneuverable device such as a paint shield is used to protectively mask a portion of the first surface when the adjoining second surface is being painted. Commercially available paint shields include a generally flat, elongated sheet of thin, flexible material such as stainless steel or aluminum, having a straight distal or working edge and an elongated handle rigidly or pivotally connected to, and extending from, the flat sheet at a mid point of the edge of the flat sheet opposite its distal edge.

By grasping the handle at its distal end and placing the distal edge tightly into a corner of an interior room between a wall and ceiling surface or between adjoining wall surfaces, the user may apply paint from a paintbrush, roller or spray gun onto the surface of, for example, the ceiling. The paint shield collects errantly applied paint on the working or exposed surface of the flexible sheet, protecting the first surface from inadvertent painting.

Commercially available paint shields have the unavoidable disadvantage of accumulating excess paint on their distal edge and working face. The accumulated paint may result in paint dripping where it is not wanted. In addition, because the distal edge is typically placed into a corner to protect the surface behind the paint shield, the paint on the distal edge may be errantly tracked to surfaces the painter is attempting to mask.

To avoid these disadvantages the painter is required to frequently clean the paint shield manually by wiping it with a cloth to remove the excess paint. Cleaning the excess paint from the paint shield is a very time consuming and cumbersome task for the painter. Time spent cleaning and maintaining the paint shield reduces effective painting time, and thereby reduces the overall efficiency gained by using a device like a paint shield in place of other devices such as masking tape.

### DESCRIPTION OF THE PRIOR ART

A number of patented devices exist for masking surfaces being painted differently than an adjacent surface. Some of the devices require repeated manual cleanings for multiple uses while others are intended for a single use and are thereafter disposed of.

U.S. Pat. No. 5,103,762 issued to Long discloses a spray paint shield for manually protectively covering a portion of a wall or ceiling when the adjoining ceiling or wall portion, respectively, is being spray painted. The spray shield includes a generally flat, elongated sheet of thin, flexible material such as stainless steel or aluminum, having a straight distal or working edge and an elongated handle pivotally connected to, and extending from, the flat sheet at a mid point of the edge of the flat sheet opposite its distal edge. A drip guard flange for collecting paint running on the working surface of the flat sheet is provided.

Users of this device must perform the cumbersome task of manually cleaning the working surface and distal edge of the flat sheet to prevent drips or errant tracking of accumulated over-spray. This burden can be even greater for painters working on ladders or scaffolding, causing them to stop work and make repeated trips to the ground to manually clean excess paint from the flat sheet.

U.S. Pat. No. 4,051,808 issued to Trupp discloses a paint shield for shielding the edges of carpets or the like while painting the bottoms of the adjoining walls. The paint shield is formed in four substantially rectangular, substantially planar parts from a single piece of sheet-like material, such as galvanized metal, aluminum, plastic, fiberglass, bakelite, hard rubber, etc.

While users of this device are not required to climb on scaffolding or ladders, they must engage in the cumbersome task of manually cleaning accumulated over-spray from the masking device to prevent drips or errant tracking of paint.

U.S. Pat. No. 4,722,442 issued to Smith discloses a drip shield device, usable with paint cans of any conventionally available size, which includes a generally circular base section having an upper abutment surface defined thereon. A containment lip extends upwardly and outwardly with respect to the base section to define a paint containment chamber. A pressure-sensitive adhesive layer extends across at least a portion of the base section to allow detachable securement of the bottom edge of a paint can with respect to the upper abutment surface of the base section. The containment lip cooperates with the base section and the paint can to define a paint containment chamber to receive and retain paint spilled down the sides of the paint can. The drip shields are stackable with respect to similarly configured drip shields due to the pressure sensitive detachable adhesive which is adaptable to be secured to a paint can as well as to a lower abutment surface of a base section thereof.

While this device provides a method for containing paint spilled down the side of paint cans to prevent paint from spilling onto a floor surface, the disclosure fails to teach any applications related to paint masking of one surface while an adjacent surface is painted.

U.S. Pat. No. 3,785,102 issued to Amos discloses a tacky floor pad for use at the entrance of a clean area. The floor pad having multiple ply construction, comprised of a plurality of very thin poly ethylene or polypropylene sheets, of suitable surface size to receive a pair of shod feet. Each sheet bearing a very thin coating of pressure-sensitive adhesive on its top surface. The lowermost sheet also having a layer of adhesive on its bottom surface to secure the pad to the floor. The pressure-sensitive adhesive on the upper surface is designed so that it grabs dirt from shoes and wheels passing over it.

The patent is directed toward to maintaining clean rooms by preventing dirt from being tracked in. The patent fails to disclose or suggest any applications related to painting or paint masking. Moreover the device is limited to placement in one location, e.g. in front of a door, and therefore lacks the portability required to be used as a paint masking device.

U.S. Pat. No. 5,658,652 discloses a masking device for caulking, painting and similar operations which includes a strip of material with multiple perforations. One side of the device may be provided with adhesive over desired areas. The adhesive may vary in strength along various regions of the surface. In use, the device is placed over the area to be caulked, painted or similarly treated. A desired portion of the masking device is peeled back and the desired operation is performed. The remaining portions of the masking device are then removed. In another embodiment of the invention, the device utilizes multiple strips, at least one of which partially overlaps another.

While this device is a masking device its masking properties are meant for single use applications. The tape is attached to the surface being masked for that use only. The disclosure fails to teach releasably stacking multiple sheets to form a pad on a portable masking device that can be used multiple times.

The above noted devices do not provide a method of renewing the masking device for multiple uses, the masking devices currently available generally require manual cleaning to remove excess paint, or are intended for disposal after a single use.

Accordingly, there is a need for an easily maneuverable paint masking device, which has a quickly renewable working surface.

### SUMMARY OF THE INVENTION

The present invention is directed to a paint shield, allowing painters using various applicators such as paintbrushes, rollers, or spray guns to quickly renew the distal edge and working surface of the paint shield in order to prevent accumulated paint or over-spray from errantly being deposited or dripped onto other surfaces during operation. The device comprises a plurality of overlying and paint impervious cover elements, in a detachably stacked relationship. Each cover element has readily releasable pressure-sensitive adhesive at least partially covering one face and being free of adhesive on the opposite face. The cover elements are stacked with the adhesive side of each element facing the non-adhesive side of the element below to maintain the elements in the form of a layered protective cover pad. The lowermost cover pad element is in contiguous contact with the working and contact surfaces of the paint shield. When an excessive amount of paint has accumulated on the surface of the top cover element, it can be peeled away to reveal a fresh cover element and operation continues until the elements are depleted. To renew the device one merely reloads a new cover pad onto the paint shield. Upon completion, removal and disposal of entire cover pad eliminates the need for cleanup.

It is therefore an objective of the present invention to provide a paint shield having convenient and easily renewable working surfaces.

Another objective of the present invention is to provide a paint shield that will materially reduce the man-hours required to maintain paint shields.

Another objective of the present invention is to provide a paint shield that utilizes a replaceable pad of disposable cover elements.

Another objective of the present invention is to provide a replaceable cover pad comprising a plurality of layered disposable cover elements and specially adapted for use with commercially available paint shields.

Still another objective of the present invention is to provide improvements to commercially available paint shields that expedite the application of various surface treatments such as paint or varnish.

Yet another objective of the present invention is to provide an unassembled renewable paint shield kit.

Other objects and advantages of this invention will become apparent from the following description taken in conjunction with the accompanying drawings wherein are set forth, by way of by way of illustration and example, certain embodiments of the invention. The drawings constitute a part of this specification and include exemplary embodiments of the present invention and illustrate objects and features thereof.

### BRIEF DESCRIPTION OF THE FIGURES

FIG. 1 is a perspective view of the present invention;

FIG. 2 is a side elevation view of FIG. 1, showing the contiguous contact of the lowermost cover element with the flat central member as well as the stacked arrangement of the cover elements to form the cover pad;

FIG. 3 is a perspective view of the bottom of the replaceable cover pad showing the cooperation of the base sheet with the lowermost cover element, the base sheet having a corner pulled back to reveal the pressure sensitive adhesive;

FIG. 4 is a side elevation view showing an alternative embodiment of the present invention.

### DETAILED DESCRIPTION OF THE INVENTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

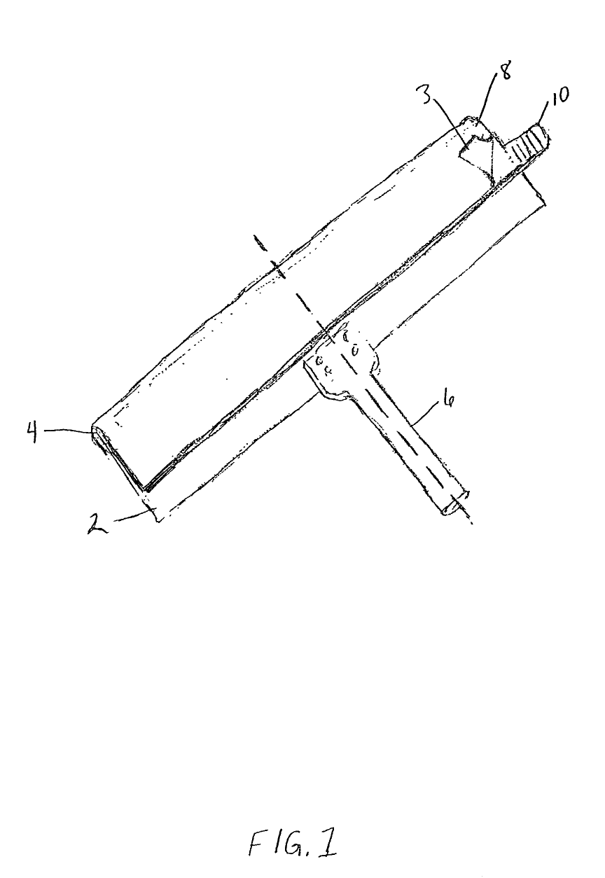

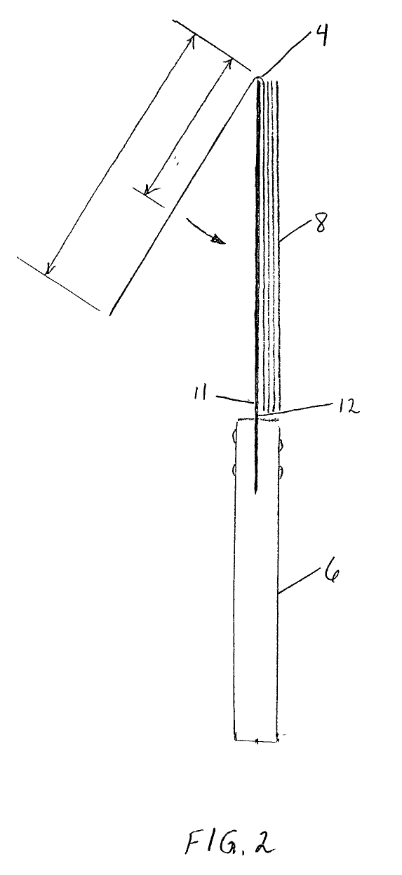

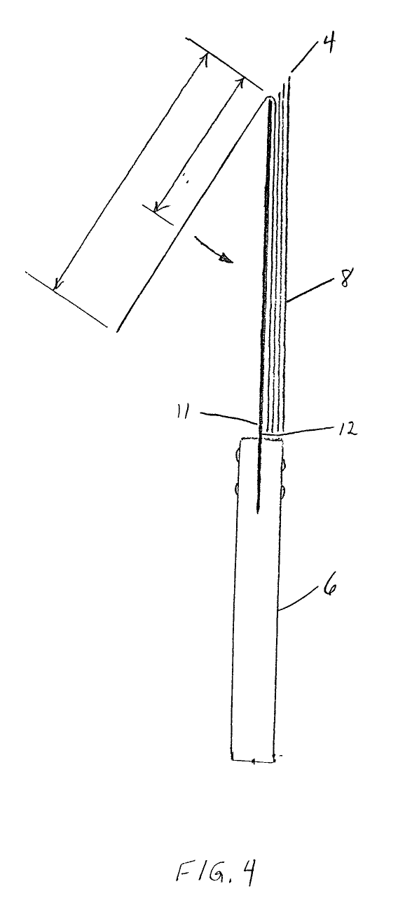

Now referring to the drawings and particularly FIGS. 1 to 4 of the present invention, it can be seen that a renewable paint shield assembly 1 is shown. The primary components of the assembly comprise a central member 2, a cover pad 8, comprised of layered elements 3, and a handle 6.

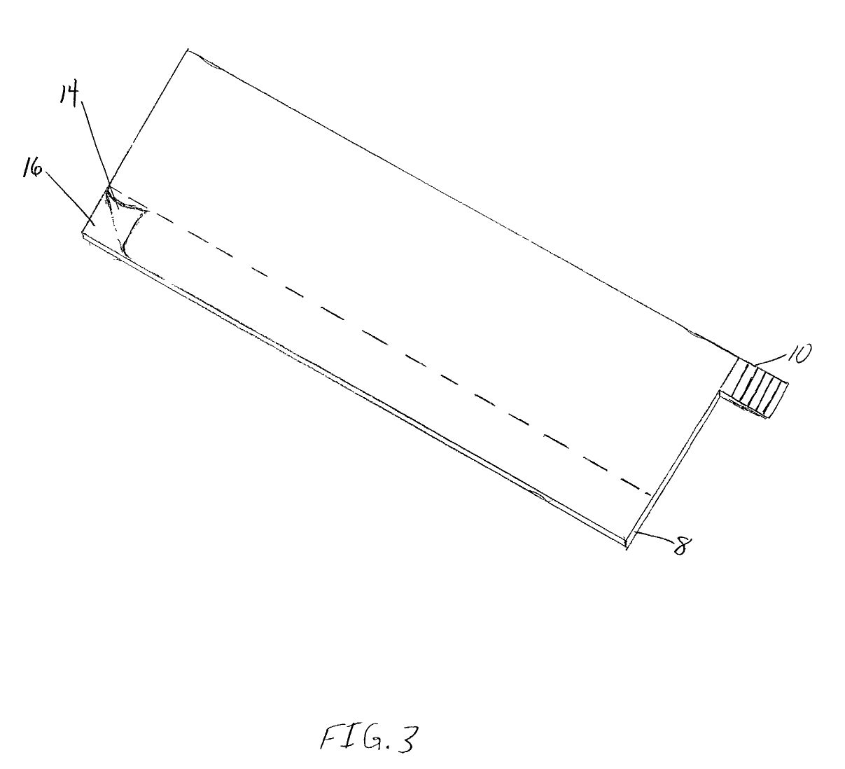

The central member 2 includes a working distal edge 4 as well as working surface 12 and a nonworking surface 11 (FIG. 3). The central member is preferably constructed of, but not limited to, thin aluminum or stainless steel plate, fiberglass or plastic having sufficient structural properties, e.g. rigidity and/or thickness so as to maintain the overall integrity and shape of the paint shield assembly 1, while being sufficiently light and flexible for ease of operation.

The cover pad 8 is releasably attached to central member 2 with a pressure-sensitive adhesive 16 or alternative attachment or fastening means, e.g. mechanical fasteners, hook and loop and the like. Central member 2 is protected by cover pad 8 the lowermost cover element in contiguous contact with working surface 12, extending around to protect distal edge 4, and partially covering non-working surface 11. In an alternative embodiment the lowermost cover element is in contiguous contact with working surface 12, extending around to protect distal edge 4, and substantially covering non-working surface 11. The cover pad 8 is constructed of a plurality of overlying and paint impervious cover elements 3. The layered cover elements 3 are disposed one on top of another, each cover element 3 having readily releasable pressure sensitive adhesive 16 at least partially covering one face and being free of adhesive on the opposite face. The cover elements 3 are stacked with the adhesive side of each cover element 3 facing the non-adhesive side of the cover element 3 below to releasably adhere the cover elements 3 forming the cover pad 8. In an alternative embodiment the cover elements 3 are stacked in an arrangement wherein the distal edge of the cover pad 8 is chamfered or tapered to allow the distal edge 4 to more closely engage the masked surface. The cover element layers 3 may be constructed of but should not be limited to materials such as paper, cloth, plastic, foils, or laminates to provide a suitable combination that will be impervious to the type of surface coating being sprayed.

Each of the cover elements 3 may include visual indicator removal means 10 to aid the operator of assembly 1 in peeling away the uppermost cover element 3. In addition the visual indicator removal means 10 may be configured so as to allow the operator of the paint shield assembly 1 to visually ascertain the number of cover elements 3 remaining on the cover pad 8. The visual indicator removal means 10 may include but should not be limited to, each cover element 3 having a corner substantially free of pressure sensitive adhesive 16, or a tab extending from the cover element 3 and substantially free of adhesive. To visually indicate the number of cover elements 3 remaining on the cover pad 8 the elements, including the tabs may be constructed using a number of combinations including but not limited to color coding, alphanumeric designations, or by progressively varying the location or length of the tabs from the uppermost cover layer to the lowermost cover layer.

For operation of the paint shield assembly 1 the distal edge 4 is placed tightly into a corner of an interior room between a working surface and a masked surface. By grasping the handle 6 at its distal end, the user may apply paint from a paintbrush, roller or paint spray gun or onto a surface, for example the ceiling, whereby over-spray or errantly applied paint will be collected on the uppermost cover element 3 of cover pad 8, rather than be inadvertently deposited against the masked surface. When the cover element 3 has accumulated an excessive amount of paint, it can be peeled away using the visual indicator removal means 10 to reveal a fresh cover element 3 and operation can continue until the cover pad 8 is depleted.

A fresh cover pad 8 may be reloaded onto the central member 2 by peeling away base sheet 14. The base sheet 14 has a coated release face and is releasably attached to the lowermost cover element 3. Removal of the base sheet 14 exposes the pressure-sensitive adhesive 16 on the lower surface of the lowermost cover element 3 for releasable contiguous attachment to the working face 12, distal edge 4, and non-working face 11 of central member 2. Upon completion, removal and disposal of the entire cover pad 8 eliminates the need for cleanup.

Additionally, this assembly may be sold as an unassembled kit containing the forgoing elements.

All patents and publications mentioned in this specification are indicative of the levels of those skilled in the art to which the invention pertains. All patents and publications are herein incorporated by reference to the same extent as if each publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A renewable and protective cover pad for use with a paint shield comprising:
a plurality of overlying and paint impervious cover elements, in a detachably stacked relationship, each said element having an upper surface and a lower surface, each said lower surface including a pressure sensitive adhesive coating upon at least a portion thereof, said elements arranged in overlying and juxtaposed relationship thereby providing a renewable and multi-use protective cover pad, said cover pad having a preformed shape for contiguous contact with said paint shield for providing substantially complete protective cover for said paint shield;
a visual indicator removal means, said means constructed and arranged to enable grasping and removal of the uppermost element while additionally allowing the quantity of said elements remaining on said cover pad to be ascertained upon visual inspection.

2. The device of claim 1 wherein said cover elements are constructed of a material selected from the group consisting of paper, cloth, plastic, metal foils, laminates or combinations thereof.

3. The device of claim 1 wherein said visual indicator removal means further includes a tab in cooperation with and extending from said cover elements, said tab being substantially free of said adhesive.

4. A renewable paint shield assembly for protectively covering a portion of a masked surface during painting comprising:
a paint shield in the form of a generally flat, elongated sheet material having a straight longitudinal working distal edge, a first side and a second side, said first side defining a working surface against which paint is collected when said distal edge is held against a masked surface and said second side defining a non-working surface in partial contact with said masked surface during operation; and
a plurality of overlying and paint impervious cover elements, in a detachably stacked relationship, each said element having an upper surface and a lower surface, each said lower surface including a pressure sensitive adhesive coating upon at least a portion thereof, said elements arranged in overlying and juxtaposed relationship thereby providing a renewable and multi-use protective cover pad, said cover pad in contiguous contact with said paint shield for providing substantially complete protective cover to said paint shield.

5. The device of claim 4 wherein said cover elements are constructed of a material selected from the group consisting of paper, cloth, plastic, metal foils, laminates or combinations thereof.

6. The device of claim 5 wherein said cover elements further comprise a visual indicator removal means, said means constructed and arranged to enable grasping and removal of the uppermost element while additionally allowing the quantity of said elements remaining on said cover pad to be ascertained upon visual inspection.

7. The device of claim 6 wherein said visual indicator removal means further includes a tab in cooperation with and extending from said cover elements, said tab being substantially free of said adhesive.

8. The device of claim 4 further comprising an elongated handle connected at one end to said elongated flat sheet.

9. A renewable paint shield kit comprising:
a paint shield in the form of a generally flat, elongated sheet material having a straight longitudinal working distal edge, a first side and a second side, said first side defining a working surface against which paint is collected when said distal edge is held against a masked surface and said second side defining a non-working surface in partial contact with said masked surface during operation; and
a plurality of overlying and paint impervious cover elements, in a detachably stacked relationship, each said element having an upper surface and a lower surface, each said lower surface including a pressure sensitive adhesive coating upon at least a portion thereof, said elements arranged in overlying and juxtaposed relationship thereby providing a renewable and multi-use protective cover pad, said cover pad in contiguous contact with said paint shield for providing substantially complete protective cover to said paint shield.

10. The kit of claim 9 wherein said cover elements are constructed of a material selected from the group consisting of paper, cloth, plastic, metal foils, laminates or combinations thereof.

11. The kit of claim 10 wherein said cover elements further comprise a visual indicator removal means, said means constructed and arranged to enable grasping and removal of the uppermost element while additionally allowing the quantity of said elements remaining on said cover pad to be ascertained upon visual inspection.

12. The kit of claim 11 wherein said visual indicator removal means further includes a tab in cooperation with and extending from said cover elements, said tab being substantially free of said adhesive.

13. The kit of claim 9 further comprising an elongated handle connected at one end to said elongated flat.
